(19) United States
(12) Patent Application Publication
(10) Pub. No.: US 2024/0163972 A1
(43) Pub. Date: May 16, 2024

(54) CONTROL OF ELECTRONIC HEATERS

(71) Applicant: Astrodyne TDI, Hackettstown, NJ (US)

(72) Inventors: Vincent G. Keiper, III, Pen Argyl, PA (US); Gary J. Mulcahy, Flanders, NJ (US)

(73) Assignee: Astrodyne TDI, Hackettstown, NJ (US)

(21) Appl. No.: 18/499,113

(22) Filed: Oct. 31, 2023

Related U.S. Application Data
(63) Continuation-in-part of application No. 17/248,598, filed on Jan. 29, 2021.

(51) Int. Cl. H05B 1/02; H05B 3/00

(52) U.S. Cl. CPC H05B 1/0202; H05B 3/0019

(57) ABSTRACT

A system, and related method, employable with an electronic heater that includes, in one embodiment, a power converter coupled to the electronic heater via a disconnect switch configured to conduct to deliver an output voltage produced by the power converter to the electronic heater to control a temperature thereof. The system also includes a current source coupled across the electronic heater, and a power converter controller configured to adjust the output voltage produced by the power converter responsive to a test current produced by the current source when the disconnect switch is not conducting.

### RELATED APPLICATION

This application is a continuation-in-part of U.S. patent application Ser. No. 17/248,598, filed on Jan. 29, 2021, entitled “Highly Adaptable Power System,” which is incorporated herein by reference.

### FIELD OF THE INVENTION

The present invention is directed in general to power electronics and, more specifically, to power control of electronic heaters.

### BACKGROUND

Electrically powered heater elements (of electronic heaters) are utilized in many manufacturing processes including semiconductor wafer processing, metal treatment, chemical processes, etc. Accurate control of delivered heat and an achieved temperature is often a requirement. Historically heat is measured independently of electrical power delivery, requiring an additional measurement apparatus and controllers to regulate a delivered temperature. Oftentimes this additional equipment can cause problems due to size, cost, and system accessibility constraints.

To produce a requisite level of temperature in a host system, electrical power is delivered to a resistive heating element of the electronic heater thermally coupled to the host system. The electronic heater is powered by a variable output, controllable, electrical power source (a power converter). The variable output of the power converter is controlled via a feedback loop that receives temperature data from temperature sensors located on or near the electronic heater, and a control input from the host system. The feedback loop is designed to provide the desired precision and timing required by the process. It is not uncommon in some system arrangements for temperature to be controlled within one degree Celsius (on the order of 0.1 percent (“%”)) of a setpoint, along with temperature update rates on the order of fractions of a second.

Temperature sensors in such arrangements are typically realized with thermocouples, resistive temperature measuring devices, bimetallic devices, change-of-state sensors, or infrared pyrometers. Electrical connections to these temperature sensors must be routed from the electronic heater back to a controller, and these connections can sometimes add significantly to overall system complexity. For example, if the electronic heater is in a vacuum chamber, any chamber penetrations require special seals to prevent air leakage. Likewise, if the chamber includes elevated levels of radio frequency (“RF”) energy as is sometimes the case in semiconductor processing, any chamber penetration must be carefully filtered to prevent RF leakage.

As introduced herein, a temperature in a host system produced by an electronic heater is automatically monitored and controlled via heater power connections. The heater power connections employ a temperature sensing arrangement that can eliminate a need for additional apparatus and cost, thereby providing a simplified system structure.

### SUMMARY

These and other problems are generally solved or circumvented, and technical advantages are generally achieved, by advantageous embodiments of the present invention. In one embodiment, a system, and related method, is employable with an electronic heater and includes a power converter coupled to the electronic heater via a disconnect switch configured to conduct to deliver an output voltage produced by the power converter to the electronic heater to control a temperature thereof. The system also includes a current source coupled across the electronic heater, and a power converter controller configured to adjust the output voltage produced by the power converter responsive to a test current produced by the current source when the disconnect switch is not conducting.

The foregoing has outlined rather broadly the features and technical advantages of the present invention in order that the detailed description of the invention that follows can be better understood. Additional features and advantages of the invention will be described hereinafter, which form the subject of the claims of the invention. It should be appreciated by those skilled in the art that the conception and specific embodiment disclosed can be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in connection with the accompanying drawings, and which:

FIG. 1 illustrates a block diagram of a power system;

FIG. 2 illustrates a block diagram of an embodiment of portions of a power converter controller;

FIGS. 3 and 4 illustrate diagrams of systems to power an electronic heater;

FIGS. 5 and 6 illustrate diagrams of systems to power first and second electronic heaters;

FIG. 7 illustrates waveforms that show timing of the disconnect switches of FIG. 6; and

FIGS. 8 to 10 illustrate diagrams of systems to power a plurality of electronic heaters.

Corresponding numerals and symbols in the different figures generally refer to corresponding parts unless otherwise indicated, and will not be redescribed in the interest of brevity after the first instance. The FIGUREs are drawn to illustrate the relevant aspects of exemplary embodiments.

### DETAILED DESCRIPTION

The making and using of the present exemplary embodiments are discussed in detail below. It should be appreciated, however, that the embodiments provide many applicable inventive concepts that can be embodied in a wide variety of specific contexts. The specific embodiments discussed herein are merely illustrative of specific ways to make and use the systems, subsystems, and modules associated with a system and method for controlling a temperature of electronic heaters in a host system.

A system will be described herein with respect to exemplary embodiments in a specific context, namely, a system for accurately controlling a temperature of an electronic heater (i.e., an electrically powered heater) in a host system. The specific embodiments include, but are not limited to employing a variable output power source (a power converter) to elevate the temperature in the host system. The principles of the present invention are applicable to other temperature management systems that are configured to elevate a temperature in the host system with a variable output power source.

An objective of the present disclosure is to accurately and controllably elevate the temperature in the host system employing an electronic heater. The elevated temperature of the electronic heater is automatically and accurately monitored via heater power configurations without introducing an unnecessary cost. The process and method utilize multiple electronic heaters sharing common conductors, and is able to provide near real-time digital control. Highly precise remote heater element measurements can be produced. Control utilizes heater power configurations for both delivery of power and monitoring of temperature.

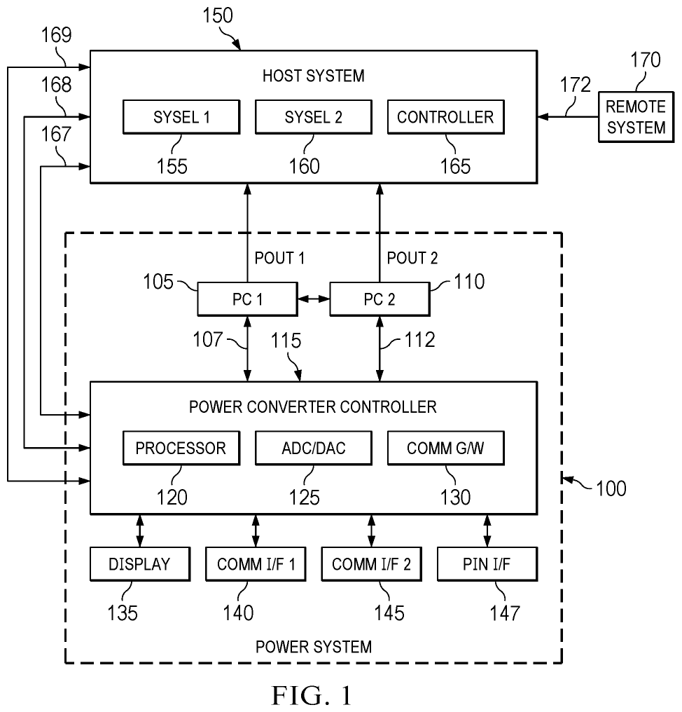

Turning now to FIG. 1, illustrated is a block diagram of an embodiment of a power system 100 formed with a plurality of power converters (designated “PC 1, PC 2”) 105, 110 controlled by a power converter controller 115. The power converters 105, 110 may comprise like or different power converter topologies. Also, ones of the power converters 105, 110 may be positioned at different locations. While only two power converters 105, 110 are illustrated, the power system 100 can include additional power converters depending on the application.

The power converter controller 115 includes a processor 120 (e.g., a microprocessor), an analog-to-digital converter/digital-to analog converter (“ADC/DAC”) 125 and a communications gateway (designated “COMM G/W”) 130. The power converter controller 115 includes local interfaces such as a display 135 (e.g., a touch screen display). The local interfaces may also include a first communications interface (designated “COMM I/F 1”) 140 such as a USB interface for communications with an external device. The local interfaces may also include a second communications interface (designated “COMM I/F 2”) 145 such as secure digital (“SD”) interface for, without limitation, inputting control parameters for the power system 100, updating firmware of the power converter controller 115, and/or logging power system data. Of course, the power converter controller 115 may include additional local interfaces depending on the application. For instance, the power converter controller 115 may include an input power interface (designated “PIN I/F”) 147 to provide input power thereto from a power bus (e.g., a 24 volt power bus). The input power interface 147 can communicate a status and/or an operational condition of power-related items such as circuit breakers, disconnect contactors, power monitors, etc.

The power system 100 powers a host system 150. The host system 150 includes a plurality of system elements (designated “SYSEL 1, SYSEL 2”) 155, 160 and a host system controller 165. While only two system elements 155, 160 are illustrated, the host system 100 can include additional system elements depending on the application. The host system 150 is coupled to a remote system 170 via a communication path 172. Of course, the host system 150 may be coupled to additional remote systems depending on the application.

The power converter controller 115 can communicate with the host system 150 over a plurality of buses. The power converter controller 115 can communicate with the host system 150 using a host system protocol over the plurality of buses. For instance, the host system 150 can provide host system signals including status information about the system elements and control command information to the power converter controller 115 over a discrete analog bus 167 and/or a serial digital bus 168. The host system signals may include discrete, real-time, analog and/or digital input signals and output signals. Conversely, the power converter controller 115 can provide power system signals including status and control information to the host system 150 with respect to the system elements 155, 160 over the discrete analog bus 167 and/or the serial digital bus 168. The power system signals may include, without limitation, power system output voltage, output current, temperature and/or status of the input power, as well as other power or host system monitoring information. The discrete analog bus 167 and/or the serial digital bus 168 are coupled to the ADC/DAC 125 of the power converter controller 115.

Additionally, the host system 150 can provide host system signals including status and control information with respect to the host system controller 165 to the power converter controller 115 over a controller bus 169 (e.g., a serial digital bus). Conversely, the power converter controller 115 can provide power system signals including status and control information to the host system 150 with respect to the host system controller 165 over the controller bus 169. The power system signals may include, without limitation, power system output voltage, output current, temperature and/or status of the input power, as well as other power or host system monitoring information. The controller bus 169 is coupled to the communications gateway 130 of the power converter controller 115. Of course, the power converter controller 115 and host system 150 may communication over additional buses depending on the application.

The controller bus 169 can be utilized for near-real-time control of delivered power to the host system 150 to provide desired host system functionality. For example, the host system 150 may employ electronic heaters, where power to the heaters controls process temperature and this temperature can be varied to achieve desired results. There are many other examples where near-real-time control and reporting on delivered power would be beneficial to the host system 150. Another important consideration is host system control latency such as the delay between where a command is issued and where the power system 100 provides the desired response, or the delay between where the power system 100 delivers a command and when the power system reports the command to the host system controller 165. Modern host systems 150 often demand command and reporting latency as low as, for instance, one to five milliseconds for desired performance. The design of the power converter controller 115 takes into account these requirements. The power converter controller 115 (via, for instance, the communications gateway 130) can provide control and communications latency of less than five milliseconds (e.g., beneficially less than one millisecond). In an embodiment, a time response of a temperature to a command is modeled to more accurately and more quickly control the time response of a temperature of the host system.

The power converter controller 115 controls the power converters 105, 110 via buses such as serial digital buses 107, 112, respectively. The power converters 105, 110 provide power (designated “POUT 1, POUT 2, respectively) to the system elements 155, 160 of the host system 150.

The power converter controller 115 provides a status of and controls the power converters 100, 110 and at least one system element 155, 160 of the host system 150 responsive to the host system signals. The control may include a scripted sequence of events from the processor 120 as a function of a change of an operational condition of at least one of the power converters 105, 110 and the host system 150. The status of the power converters 105, 110 and at least one system element 155, 160 of the host system 150 may be displayed on the display 135. In addition to monitoring at least one system element 155, 160 of the host system 150, the power converter controller 115 can monitor a status of and control the remote system 170 as well.

As an example, the power system controller 115 can provide a scripted sequence of events (or responses) related to a safety system (a system element 155, 160 or remote system 170) associated with the host system 150. The scripted sequence of events can be related to, for example, an emergency power cutoff contactor (a system element 155, 160 or remote system 170) that cuts off power to the host system 150, as well as interlocks (a system element 155, 160 or remote system 170) that are outside the power system 100. Host system signals (that apply to the system elements 155, 160 and remote systems 170) can be routed to the power converter controller 115 for the scripted sequence of events to control the power converters 105, 110, the host system 150 and/or the remote system 170. As further examples, the system element 155, 160 may include, without limitation, a leak detector, and/or a temperature sensor that can be controlled by the power converter controller 115.

Thus, the power converter controller 115 can be configured to operate as a central control point for power and system management. As non-limiting examples, other system sensor signals such as air conditioner monitor signals, contactor status signals, general relay board status signals, and signals that can prevent the power system 100 from powering on can also be coupled to the power converter controller 115 employing an appropriate protocol.

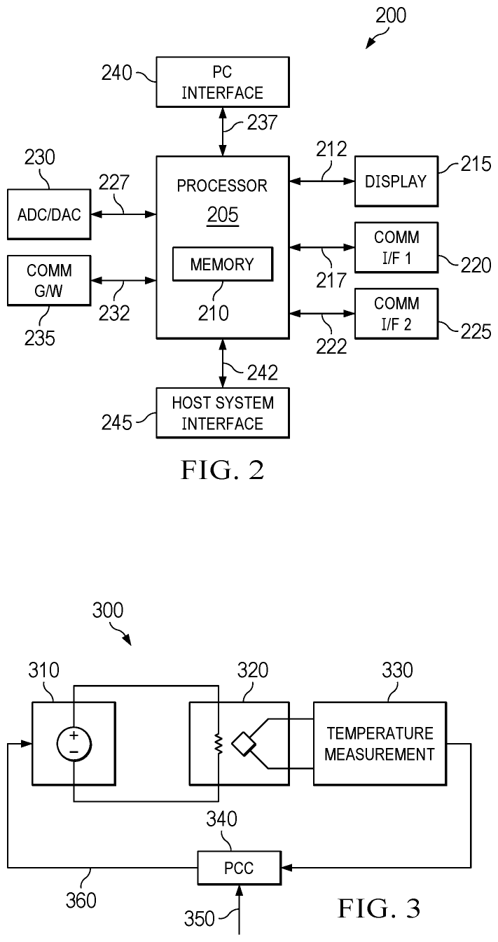

Turning now to FIG. 2, illustrated is a block diagram of an embodiment of portions of a power converter controller 200 of a power system (see, e.g., FIG. 1). As illustrated in FIG. 2, a processor 205 (e.g., a microprocessor) is utilized as a communications and control hub. This includes communications with a host system via, for instance, Ethernet, CANbus, USB, or an isolated low voltage discrete signal (“LVDS”) serial peripheral interface bus (“SPIbus”). An LVDS SPIbus provides a fast, robust, and relatively noise-immune communication link. When an SPIbus is utilized, a third party communications bridge, such as the HMS Anybus product, can be implemented to support other host communication protocols, such as Ethernet, Ethercat, Profinet, CANbus, RS232, I2C, USB, or others.

Power system internal communications can be accomplished via CANbus to connected power converters, or via discrete digital and/or analog signals, as appropriate. Discrete input/output (“I/O”) ports can also be used for host system communication and control, as desired or needed. The processor 205 can also interface to a display 215 (e.g., a touch screen display) for local, manual control of the power system.

The processor 205 in conjunction with memory 210 (e.g., embedded memory such as electrically erasable programmable read-only memory (“EEPROM”)) provides real-time operating system control, as well as serving as a repository of various system control algorithms, wherein a plurality of power converters can be amalgamated into a single entity from control and reporting standpoints. Likewise, various operational scripts (scripted sequence of events or responses) can be implemented, such as controlling startup, shutdown, sequencing, control limits, as well as other parameters, of the power system and host system.

FIG. 2 illustrates example inputs and outputs of the power converter controller 200 demonstrating communication with, for instance, power system components, the host system, and remote systems. A display bus 212 (e.g., I2C external bus interface pan bus) provides communication with the display 215. A first communications interface bus 217 provides communication with a first communications interface (designated “COMM I/F 1”) 220. For the example of FIG. 1, a USB bus (the first communications interface bus 217) provides communication with a USB interface (the first communications interface 215) for a USB device (an external device). A second communications interface bus 222 provides communication with a second communications interface (designated “COMM I/F 2”) 225. For the example of FIG. 1, an SD bus (the second communications interface bus 222) provides communication with an SD interface (the second communications interface 225) for an SD card.

An ADC/DAC bus 227 (e.g., an SPIbus) provides communication with an ADC/DAC 230. A communications gateway bus 232 (e.g., a serial digital bus) provides communication with a communications gateway (designated “COMM G/W”) 235. A power converter bus 237 (e.g., a serial digital bus, CANbus) provides communication with a power converter interface (designated “PC INTERFACE”) 240. A host system bus 242 (e.g., a CANbus) provides communication with a host system interface 245 for, without limitation, system elements of the host system or a remote system. Of course, other buses and interfaces are well within the scope of the present disclosure.

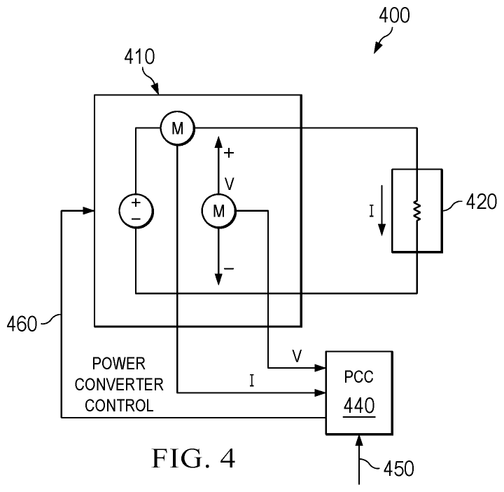

Turning now to FIG. 3, illustrated is a diagram of a system 300 to power an electronic heater 320. A power converter 310 is coupled to the electronic heater 320. The electronic heater 320 is thermally coupled to a component in the host system such as a resistive heating element. A temperature measurement sensor 330 senses the temperature of the component in the host system. The temperature measurement sensor 330 can be realized, without limitation, with a thermocouple, a resistive temperature sensing device, a bimetallic device, a change-of-state sensor, and/or an infrared pyrometer. A power converter controller (“PCC”) 340 receives a temperature control input signal 350 indicating the temperature to which the host system will be controlled. A power converter control signal 360 produced by the controller 340 is employed to control the variable output of the power converter 310.

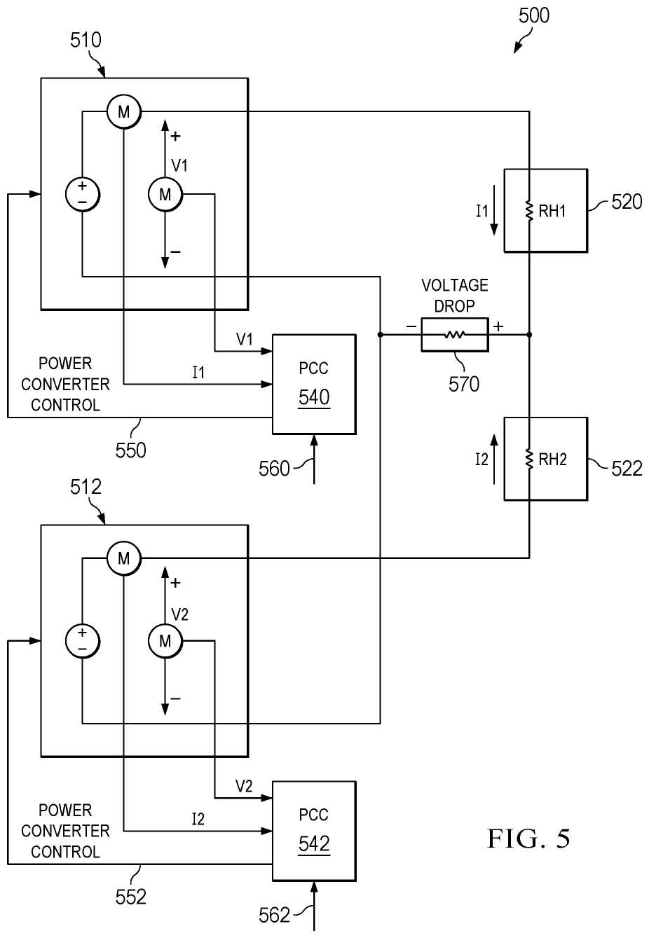

Turning now to FIG. 4, illustrated is a diagram of a system 400 to power an electronic heater 420. The system 400 utilizes heater power connections for temperature measurements for heater control. The system 400 utilizes a resistive temperature measuring device that has a known temperature-versus-resistance characteristic to determine the measured temperature. This principle can also be applied to the resistive electronic heater 420. If the delivered voltage (“V”) and current (“I”) are monitored, the resistance (“Relement”) of the resistive temperature measuring device can be determined utilizing Ohm's Law as Relement=V/I.

As illustrated in FIG. 4, real-time measurements of output voltage V and current I of a power converter 410 are fed back to a power converter controller (“PCC”) 440. The circles with the letter “M” in FIG. 4 (and in later FIGUREs) symbolically represent measurement devices or sensors such as voltage or current measurement devices. The power converter controller 440 receives a temperature control input signal 450 indicating the temperature to which the host system will be controlled. The power converter controller 440 employs these measured values of voltage V or current I to compute heater resistance by dividing its voltage by its current. The heater resistance value is then compared to heater temperature versus resistance data to determine the heater temperature. A power converter control signal 460 produced by the power converter controller 440 is fed back to the power converter 410, which adjusts its output voltage V to either increase or decrease power delivered to the electronic heater 420 to bring the temperature of the host system to the desired temperature.

While this system 400 can be quite effective at regulating heater temperature, there are some drawbacks that need to be considered. If power levels are high, the power converter 410 may generate electrical noise that can corrupt the fed-back values, thereby decreasing accuracy. Likewise, current measurements at higher output currents tend to be sensitive to transducer temperature drift, which decreases accuracy as power levels and time vary. If the power converter 410 operates with an ac output voltage (as opposed to a dc output voltage), monitoring of the root mean square (“RMS”) values of output current and voltage add complexity, potential errors and time delays to the system. If multiple power converters are utilized to power multiple electronic heaters, and these electronic heaters share a common return conductor, multiple currents flowing in the common return conductor can reduce accuracy of the heater resistance measurements, thereby decreasing sensed temperature accuracy.

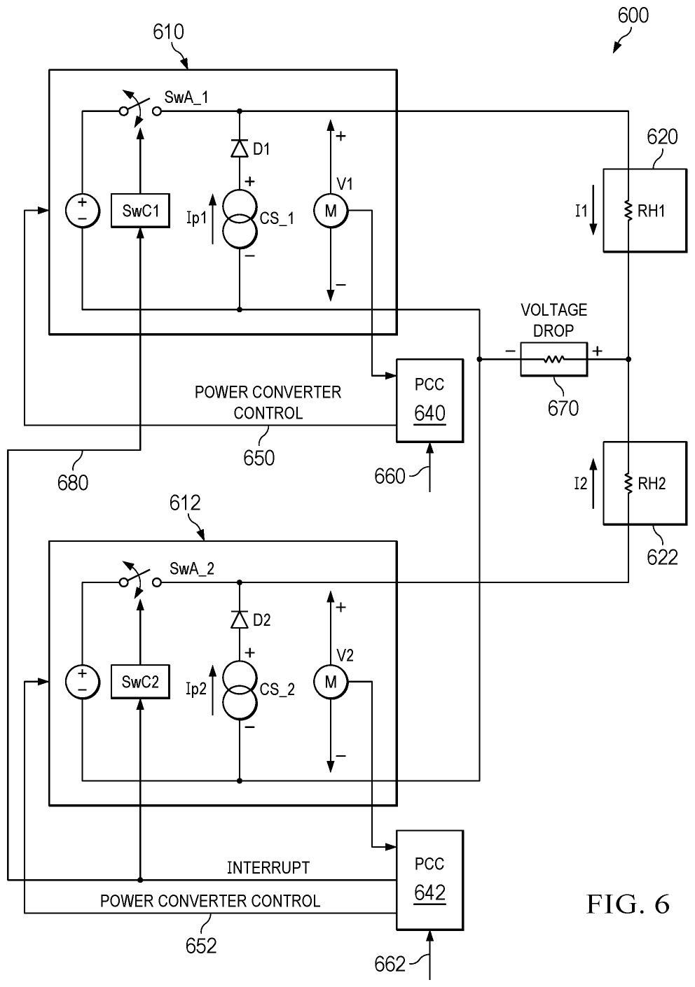

Turning now to FIG. 5, illustrated is a diagram of a system 500 to power first and second electronic heaters 520, 522. The system 500 utilizes a common return conductor 570 for powering a plurality of electronic heaters (the first and second electronic heaters) 520, 522. Power converter control signals 550, 552 produced by the first and second power converter controllers (“PCC”) 540, 542 are fed back to the first and second power converters 510, 512 that adjust their output voltages V1, V2 to either increase or decrease power delivered to the electronic heaters 520, 522 to bring the temperature of the host system to the desired temperature (via temperature control input signals 560, 562). As illustrated in FIG. 5, the two independent electronic heaters 520, 522 share the common return conductor 570 back to their respective first and second power converters 510, 512. The output voltage V1 monitored at the first power converter output then becomes (I1×RH1)+(I1+I2)×RRC, where I1 is the current in the first electronic heater 520, RH1 is the resistance of the first electronic heater 520, I2 is the current in the second electronic heater 522, and RRC is the resistance of the common return conductor 570. The symbol “x” represents a multiply operation. The output voltage V2 monitored at the second power converter output then becomes (I2×RH2)+(I1+I2)×RRC, where RH2 is the resistance of the second electronic heater 522.

If each electronic heater resistance is relatively modest (for example, less than 10 ohms) and power in each electronic heater 520, 522 is relatively high (e.g., greater than 1000 watts (“W”)), then currents I1, I2 will be on the order of 10 amperes (“A”) per electronic heater 520, 522. Likewise, if the resistance of the common return conductor 570 is on the order of 0.05 ohms, which is equivalent to a one volt voltage drop when conducting 20 A (power in the common return conductor 570 is 20 W, or about 1% of the total power delivered), the voltage drop on the common return conductor 570 will vary by 0.5 volts (“V”) as the currents I1, I2 for each electronic heater 520, 522 varies from 0 to 10 A. If the nominal voltage for each electronic heater 520, 522 at 10 A is 100 V, a 0.5 V error in the measured voltage V1, V2 translates to a 0.5% error, which can translate to a temperature error that is unacceptable in many applications. This effect is further amplified if additional electronic heaters share a common return conductor 570.

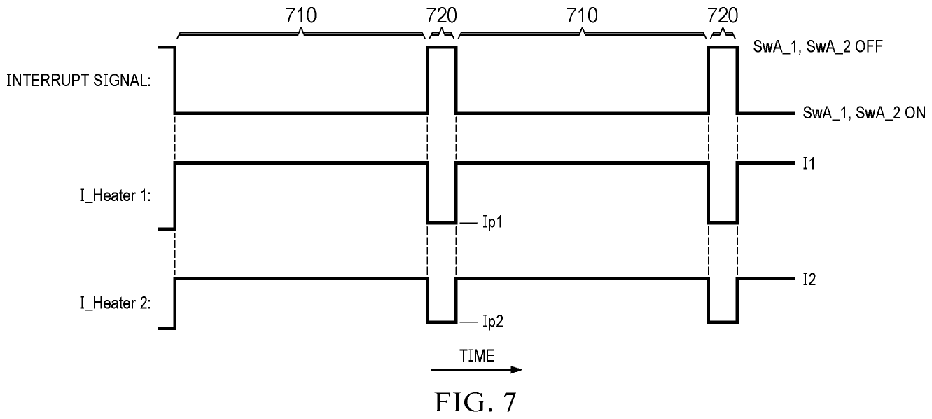

Turning now to FIG. 6, illustrated is a diagram of a system 600 to power first and second electronic heaters 620, 622. The system 600 avoids the effects of a common return conductor 670 on measured heater resistance values. A common return conductor 670 can be employed to provide a return power path for powering a plurality of electronic heaters (the first and second electronic heaters 620, 622). The two independent electronic heaters 620, 622 share the common return conductor 670 back to their respective power converters 610, 612. Power converter control signals 650, 652 produced by first and second power converter controllers (“PCC”) 640, 642 are fed back to the power converters 610, 612 that adjust their output voltages V1, V2 to either increase or decrease power delivered to the first and second electronic heaters 620, 622 to bring the temperature of the host system to the desired temperature (via temperature control input signals 660, 662).

As illustrated in FIG. 6, each power converter 610, 612, includes a disconnect switch SwA_1, SwA_2 (each under control of a respective switch controllers SwC1, SwC2) in series with its respective output. Also included are current sources CS_1, CS_2 (each providing a test current Ip1, Ip2) coupled across the respective output of the power converters 610, 612. Illustrating a design example, the current sources CS_1, CS-2 are constant current sources, which also may be varying currents. The current sources CS_1, CS-2 may be configured as part of the power converters 610, 612, or can be connected external to the power converters 610, 612. These current sources CS_1, CS_2 are utilized to implement a load resistance measurement process that avoids the effects of multiple heater currents in the common return conductor 670. Accurate load resistance measurements enable accurate host temperatures to be determined.

The controller, collectively the first and second power converter controllers 640, 642, can provide an interrupt signal 680 that is routed respectively to both power converters 610, 612 (to the respective switch controllers SwC1, SwC2). This interrupt signal 680 is configured to interrupt power flow from the first and second power converters 610, 612 to the first and second electronic heaters 620, 622 by turning OFF the respective disconnect switches SwA_1, SwA_2 (via the respective switch controllers SwC1, SwC2) for a brief period of time and with a short duty cycle, typically on the order of 10%. The interrupt time is chosen so that thermal inertia in the host system produces an insignificant host system temperature change during this period of power interruption.

When power is interrupted, each power converter 610, 612 is presented with the test current Ip1, Ip2. The output voltages V1, V2 at the outputs of the power converters 610, 612 are also measured during this period of power interruption so that resistance of each electronic heater 620, 622 plus wiring connections is equal to Vheater/Ip (i.e., heater voltage divided by the respective test current Ip1, Ip2). Note that the heater voltage Vheater is equal to the output voltages V1, V2 of the corresponding power converter 610, 612 minus the voltage drop of the common return conductor 670 for each electronic heater 620, 622.

Resistance measurements are conducted with dc signals, regardless of the nature of the heater power signal. This simplifies the measurement methodology as RMS values need not be determined. While the common return conductor 670 will be carrying multiple test current signals during the measurement period, the test currents Ip1, Ip2 typically do not vary very much, and any effects of these test currents Ip1, Ip2 are accounted for during system calibration. Overall delivered power requirements from the power converters 610, 612 are modestly increased by a factor of 1/DF, where DF is the duty cycle (also referred to as duty factor (“DF”)) of the interrupt signal 680. For a DF of 0.9, delivered power increases by 11% (more precisely, 1/0.9) to maintain the power that would be delivered with no interruption.

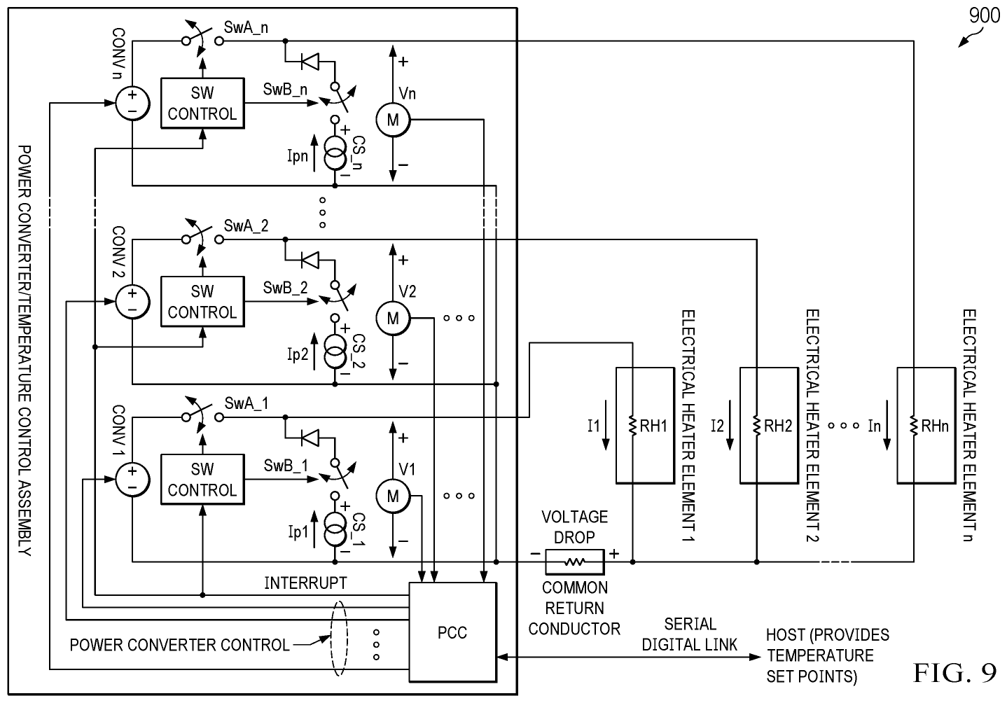

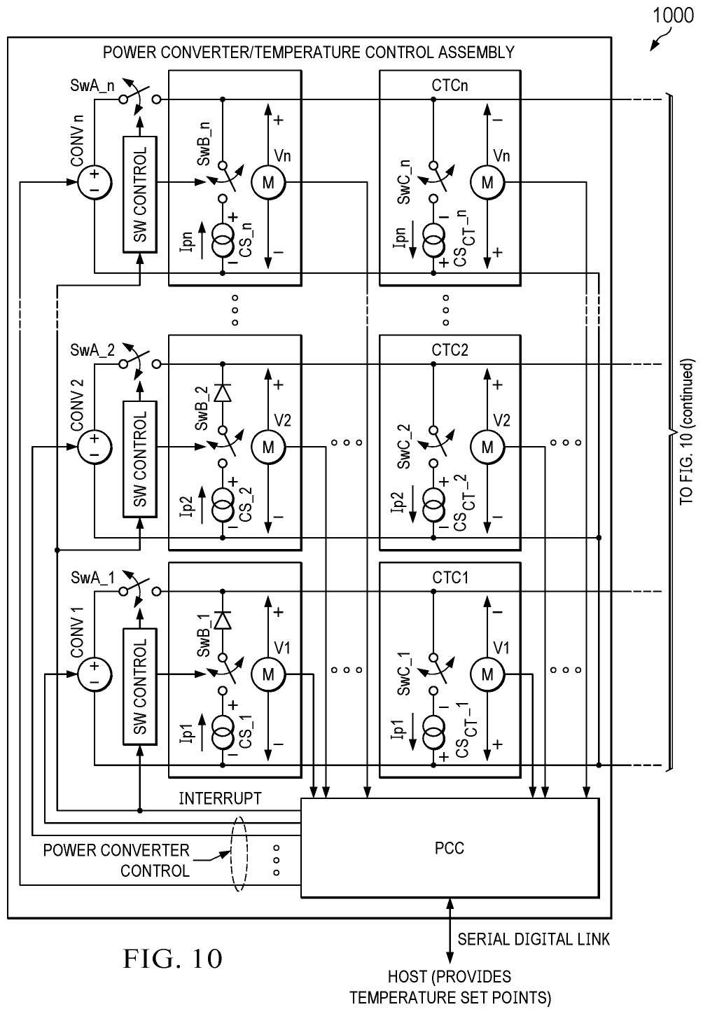

Overall heater resistance measurement accuracy and precision will be dictated by the initial accuracy of the respective test current source CS_1, CS_2, the accuracy of the voltage measurement circuit, and effects of connection leads. These can be compensated for as part of an initial calibration procedure. Various options for control circuit implementation are available. As illustrated in FIG. 6, the controller, collectively first and second power converter controllers 640, 642, can provide timing signals, calculate heater resistance RH1, RH2, and translate this to equivalent temperature values. The controller can control power flow for the electronic heaters 620, 622. The diodes D1, D2 shown in series with the current sources CS_1, CS_2 in FIG. 6 (and in FIGS. 8 and 9) protect the current sources CS_1, CS_2 from high voltages (e.g., voltages above (e.g., substantially) the regulated (controllable) output voltages V1, V2 of the respective power converter 510, 512). This implementation assumes dc power for the electronic heaters 620, 622 of a value that is greater than the bias voltage for the current sources CS_1, CS_2.

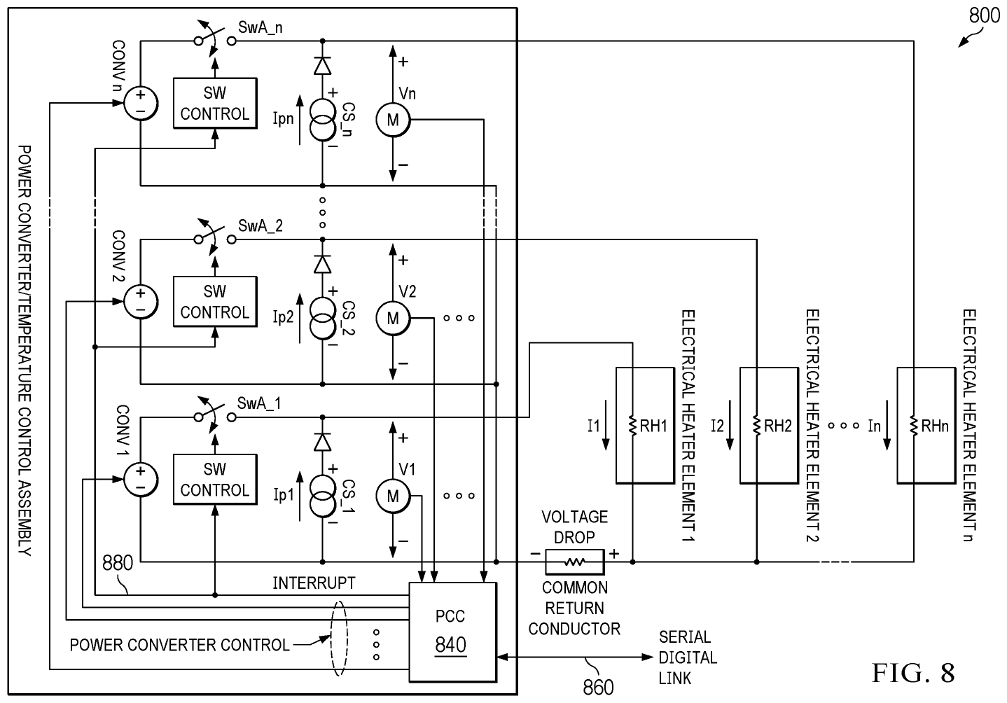

Turning now to FIG. 7, illustrated are waveforms that show timing of the disconnect switches SwA_1, SwA_2 of FIG. 6. The upper waveform illustrates the interrupt signal 680 and the other waveforms illustrate the current I1, I2 in the first and second electronic heaters 620, 622, respectively. When the interrupt signal 680 is disabled from the controller, the disconnect switches SwA_1, SwA_2 are ON (closed or conducting) under control of the respective switch controllers SwC1, SwC2, and the first and second electronic heaters 620, 622 are ON powered by the respective first and second power converters 610, 612 (see time intervals 710). Conversely, when the interrupt signal 680 is enabled from the controller, the disconnect switches SwA_1, SwA_2 are OFF (open or not conducting) under control of the respective switch controllers SwC1, SwC2, and the first and second electronic heaters 620, 622 are operated at a reduced power level via the respective current sources CS_1, CS_2 (see time intervals 720). As mentioned above, the interrupt signal 680 is configured to interrupt power flow from the first and second power converters 610, 612 to the first and second electronic heaters 620, 622, respectively, for a brief period of time and with a short duty cycle, typically on the order of 10%.

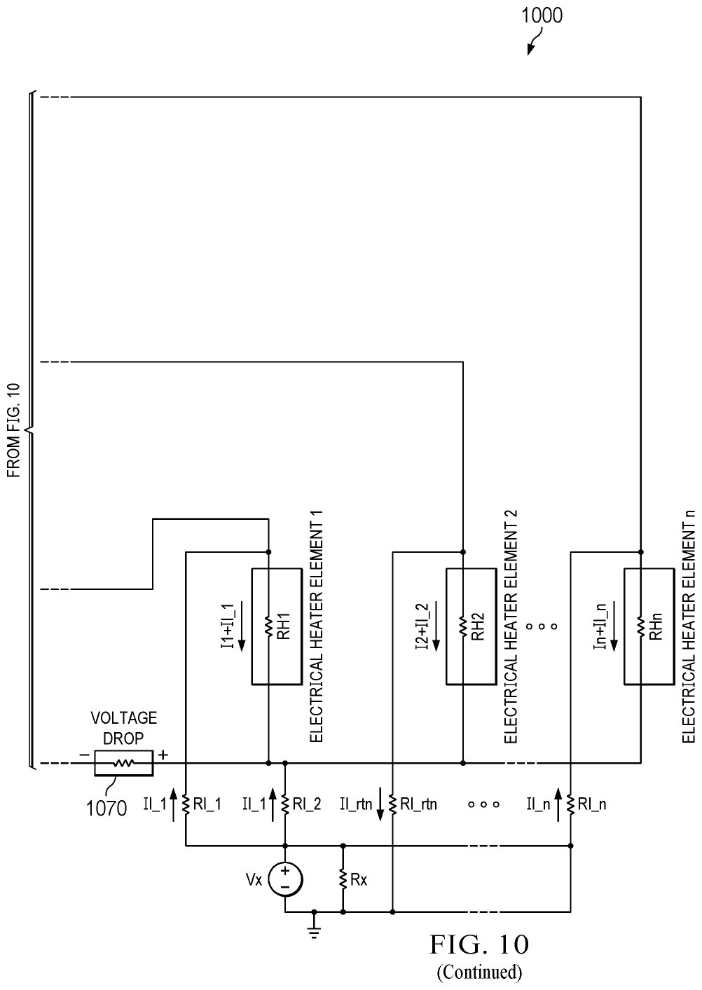

As illustrated in FIG. 8, a central power converter controller (“PCC”) 840 of a system 800 can provide timing signals for a plurality of electronic heaters (“Electrical Heater Elements 1, 2, . . . n”, also “EHE1, 2, . . . n”) powered by respective power converters (“Conv 1, 2, . . . n”). A common return conductor 870 can be employed to provide a return power path from the plurality of electronic heaters to the power converters. The components of the system 800 illustrated in FIG. 8 (and FIGS. 9 and 10) are similar to those illustrated and described hereinabove with reference to FIG. 6, and will not be redescribed in the interest of brevity. FIG. 8 also illustrates an interrupt signal 880 that can be employed with a serial digital control interface. The interrupt signal 880 can be utilized when control and calculation of heater resistance is performed within the power converter(s). These then respond to a temperature control signals 860 (corresponding to temperature set points) provided by the host system.

As illustrated in FIG. 9, a system 900 includes additional switches (“SwB_1, 2, . . . n”, another disconnect switch(es)) that can disconnect current sources (“CS_1, 2, . . . n”) when, for instance, power is being applied to a plurality of electronic heaters (“Electrical Heater Elements 1, 2, . . . n”, also “EHE1, 2, . . . n”) via the respective conducting disconnect switches (“SwA_1, 2, . . . n”) of the respective power converters (“Conv 1, 2, . . . n”). Additionally, when the disconnect switches (“SwA_1, 2, . . . n”) are OFF (open or not conducting) and the respective disconnect switches (“SwB_1, 2, . . . n”) are OFF (open or not conducting), the respective electronic heaters (“Electrical Heater Elements 1, 2, . . . n”) are also OFF. If heater power is AC in nature, or if heater power can be adjusted below the bias of the current source, the circuitry shown in FIG. 9 can be utilized.

Turning now to FIG. 10, illustrated is a system 1000 including a crosstalk circuit (“CTC1, 2, . . . n”) that accommodates “crosstalk” in a plurality of electronic heaters (“Electrical Heater Element 1, 2, . . . n”, also “EHE1, 2, . . . n”). This occurs when the electronic heaters share a common return conductor 1070 with other independently powered elements, and leakage currents (“Il_1, 2, . . . n”) are formed among these elements (i.e., there is return current “crosstalk”). These leakage currents can cause errors in the calculated heater resistance (“RH1, 2, . . . n”) because they are not anticipated by the current sources (“CS_1, 2, . . . n”). The crosstalk circuit (“CTC1, 2, . . . n”) includes a crosstalk circuit current source (“CS_{CT}_1, 2, . . . n”) in series with a switch (“SwC_1, 2, . . . n”).

To reduce or eliminate these effects, positive and negative polarity current sources (“CS_{CT}_1, 2, . . . n”) providing test current (“Ip1, 2 . . . n”), which may be different that the test current from the respective test current from the current sources (“CS_1, 2, . . . n”) are implemented as shown in FIG. 10. The current sources (“CS_{CT}_1, 2, . . . n”) are switched in 50% of the time positive and the other 50% negative. The resulting output voltages (“V1, 2, . . . n_pos, V1, 2, . . . n_neg”) on the electronic heaters with a resistance (“RH1, 2, . . . n”) and with leakage current (“Il_1, 2, . . . n”) and test currents (“Ip1, 2, . . . n”) are given as follows.

During the positive current source interval for each electronic heater:

V1,2, . . . n_pos=(Il1,2, . . . n+Ip1,2, . . . n)×RH1,2, . . . n.

During the negative current source interval for each electronic heater:

V1,2, . . . n_neg=(Il1,2, . . . n−Ip1,2, . . . n)×RH1,2, . . . n.

The time-averaged signal for each electronic heater is:

Vave1,2, . . . n=½×(V1,2, . . . n_pos+V1,2, . . . n_neg);

Vave1,2, . . . n=½×((Il1,2, . . . n+Ip1,2, . . . n)×RH1,2, . . . n+(Il1,2, . . . n−Ip1,2, . . . n)×RH1,2, . . . n);

Vave1,2, . . . n=Il1,2, . . . n×RH1,2, . . . n.

Once this term is determined, then the heater resistance can be calculated as via output voltages:

V1,2, . . . n=V1,2, . . . ,n−Il1,2, . . . n×RH1,2, . . . n.

In this manner, the effects of leakage currents induced by other system voltages can be reduced or eliminated.

Thus, a system that can operate with either AC or DC power applied to an electronic heater has been introduced herein. The system utilizes electrical heater resistance to monitor delivered temperature. The system employs independent current source(s) and measuring device(s) such as voltage meter(s) to determine heater resistance during a momentary interruption of heater power flow. This negates effects of power converter self-heating and electronic noise within the power converter. The system can utilize either an analog or serial digital interface to the host system.

The system can also utilize two independent current sources of opposite polarity, and a voltage meter to determine heater resistance during a momentary interruption of heater power flow. The system can compensate for externally induced leakage currents in the electronic heaters. The system can compensate for errors generated through use of common feed or return conductors for the electronic heaters.

In one embodiment, the system (600) (and related method of operating the same) is employable with an electronic heater (620) and includes a power converter (610) coupled to the electronic heater (620) via a disconnect switch (SwA_1) configured to conduct to deliver an output voltage (V1) produced by the power converter (610) to the electronic heater (620) to control a temperature thereof. The system (600) also includes a current source (CS_1) coupled across the electronic heater (620), and a power converter controller (640) configured to adjust the output voltage (V1) produced by the power converter (610) responsive to a test current (Ip1) produced by the current source (CS_1) when the disconnect switch (SwA_1) is not conducting. The electronic heater (620) is configured to be ON when the disconnect switch (SwA_1) is conducting and the electronic heater (620) is configured to operate at a reduced power level when the disconnect switch (SwA_1) is not conducting.

The system (600) also includes a switch controller (SwC1) configured to control conduction of the disconnect switch (SwA_1). The switch controller (SwC1) is configured to control conduction of the disconnect switch (SwA_1) responsive to an interrupt signal (680). The disconnect switch (SwA_1) is configured to conduct when the interrupt signal (680) is disabled and the disconnect switch (SwA_1) is configured not to conduct when the interrupt signal (680) is enabled.

The system (600) also includes a diode (D1) in series with the current source (CS_1) configured to protect the current source (CS_1) from voltages above a controllable output voltage (V1) of the power converter (610). The system (600, 900) may also include another disconnect switch (SwB_1) in series with the current source (CS_1) configured to disconnect the current source (CS_1) from the electronic heater (620, EHE1).

In another embodiment, the system (800) (and related method of operating the same) is employable with first and second electronic heaters (EHE1, EHE2) and includes a first power converter (Conv 1) coupled to the first electronic heater (EHE1) via a first disconnect switch (SwA_1) configured to conduct to deliver a first output voltage (V1) produced by the first power converter (Conv 1) to the first electronic heater (EHE1) to control a temperature thereof. The system (800) also includes a second power converter (Conv 2) coupled to the second electronic heater (EHE2) via a second disconnect switch (SwA_2) configured to conduct to deliver a second output voltage (V2) produced by the second power converter (Conv 2) to the second electronic heater (EHE2) to control a temperature thereof, The first and second electronic heaters (EHE1, EHE2) share a common return conductor (870) to the first and second power converters (Conv 1, Conv 2). The system (800) also includes a first current source (CS_1) coupled across the first electronic heater (EHE1), and a second current source (CS_2) coupled across the second electronic heater (EHE2). The system (800) also includes a power converter controller (840) configured to adjust the first and second output voltages (V1, V2) produced by the first and second power converters (Conv 1, Conv 2), respectively, responsive to first and second test currents (Ip1, Ip2), respectively, produced by the first and second current sources (CS_1, CS_2), respectively, when the first and second disconnect switches (SwA_1, SwA_2), respectively, are not conducting. The first and second electronic heaters (EHE1, EHE2) are configured to be ON when the first and second disconnect switches (SwA_1, SwA_2), respectively, are conducting and the first and second electronic heaters (EHE1, EHE2) are configured to operate at a reduced power level when the first and second disconnect switches (SwA_1, SwA_2), respectively, are not conducting.

The system (800) also includes first and second switch controllers (SwC1, SwC2) configured to control conduction of the first and second disconnect switches (SwA_1, SwA_2), respectively. The first and second switch controllers (SwC1, SwC2) are configured to control conduction of the first and second disconnect switches (SwA_1, SwA_2), respectively, responsive to an interrupt signal (880) from the power converter controller (840). The first and second disconnect switches (SwA_1, SwA_2) are configured to conduct when the interrupt signal (880) is disabled and the first and second disconnect switches (SwA_1, SwA_2) are configured not to conduct when the interrupt signal (880) is enabled.

The system (800) also includes first and second diodes (D1, D2) in series with the first and second current sources (CS_1, CS_2), respectively, configured to protect the first and second current sources (CS_1, CS_2), respectively, from voltages above first and second controllable output voltages (V1, V2,), respectively, of the first and second power converters (Conv 1, Conv 2), respectively. The system (800, 900) also includes another first and second disconnect switches (SwB_1, SwB_2) in series with the first and second current sources (CS_1, CS_2), respectively, configured to disconnect the first and second current sources (CS_1, CS_2), respectively, from the first and second electronic heaters (EHE1, EHE2), respectively The system (800, 1000) also includes first and second crosstalk circuits (CTC1, CTC2) coupled across the first and second current sources (CS_1, CS_2), respectively, and to the common return conductor (870, 1070) configured to reduce effects of first and second leakage currents (Il_1, Il_2) associated with the first and second electronic heaters (EHE1, EHE2), respectively.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same can be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized as well. Accordingly, the appended claims are intended to include within their scope such processes, machines, manufacture, compositions of matter, means, methods, or steps.

What is claimed:

1. A system employable with an electronic heater, comprising:
a power converter coupled to said electronic heater via a disconnect switch configured to conduct to deliver an output voltage produced by said power converter to said electronic heater to control a temperature thereof;
a current source coupled across said electronic heater; and
a power converter controller configured to adjust said output voltage produced by said power converter responsive to a test current produced by said current source when said disconnect switch is not conducting.

2. The system as recited in claim 1 wherein said electronic heater is configured to be ON when said disconnect switch is conducting and said electronic heater is configured to operate at a reduced power level when said disconnect switch is not conducting.

3. The system as recited in claim 1 further comprising a switch controller configured to control conduction of said disconnect switch.

4. The system as recited in claim 3 wherein said switch controller is configured to control conduction of said disconnect switch responsive to an interrupt signal.

5. The system as recited in claim 4 wherein said disconnect switch is configured to conduct when said interrupt signal is disabled and said disconnect switch is configured not to conduct when said interrupt signal is enabled.

6. The system as recited in claim 1 further comprising a diode in series with said current source configured to protect said current source from voltages above a controllable output voltage of said power converter.

7. The system as recited in claim 1 further comprising another disconnect switch in series with said current source configured to disconnect said current source from said electronic heater.

8. A system employable with first and second electronic heaters, comprising:
a first power converter coupled to said first electronic heater via a first disconnect switch configured to conduct to deliver a first output voltage produced by said first power converter to said first electronic heater to control a temperature thereof;
a first current source coupled across said first electronic heater;
a second power converter coupled to said second electronic heater via a second disconnect switch configured to conduct to deliver a second output voltage produced by said second power converter to said second electronic heater to control a temperature thereof, said first and second electronic heaters sharing a common return conductor to said first and second power converters;
a second current source coupled across said second electronic heater; and
a power converter controller configured to adjust said first and second output voltages produced by said first and second power converters, respectively, responsive to first and second test currents, respectively, produced by said first and second current sources, respectively, when said first and second disconnect switches, respectively, are not conducting.

9. The system as recited in claim 8 wherein said first and second electronic heaters are configured to be ON when said first and second disconnect switches, respectively, are conducting and said first and second electronic heaters are configured to operate at a reduced power level when said first and second disconnect switches, respectively, are not conducting.

10. The system as recited in claim 8 further comprising first and second switch controllers configured to control conduction of said first and second disconnect switches, respectively.

11. The system as recited in claim 10 wherein said first and second switch controllers are configured to control conduction of said first and second disconnect switches, respectively, responsive to an interrupt signal from said power converter controller.

12. The system as recited in claim 11 wherein said first and second disconnect switches are configured to conduct when said interrupt signal is disabled and said first and second disconnect switches are configured not to conduct when said interrupt signal is enabled.

13. The system as recited in claim 8 further comprising first and second diodes in series with said first and second current sources, respectively, configured to protect said first and second current sources, respectively, from voltages above first and second controllable output voltages, respectively, of said first and second power converters, respectively.

14. The system as recited in claim 8 further comprising another first and second disconnect switches in series with said first and second current sources, respectively, configured to disconnect said first and second current sources, respectively, from said first and second electronic heaters, respectively.

15. The system as recited in claim 8 further comprising first and second crosstalk circuits coupled across said first and second current sources, respectively, and to said common return conductor configured to reduce effects of first and second leakage currents associated with said first and second electronic heaters, respectively.

16. A method employable with an electronic heater, comprising:
delivering an output voltage produced by a power converter to said electronic heater to control a temperature thereof when a disconnect switch therebetween is conducting; and
adjusting said output voltage produced by said power converter with a power converter controller responsive to a test current produced by a current source, coupled across said electronic heater, when said disconnect switch is not conducting.

17. The method as recited in claim 16 wherein said electronic heater is ON when said disconnect switch is conducting and said electronic heater operates at a reduced power level when said disconnect switch is not conducting.

18. The method as recited in claim 16 further comprising providing a disconnect signal, said disconnect switch conducting when said interrupt signal is disabled and said disconnect switch not conducting when said interrupt signal is enabled.

19. The method as recited in claim 16 further comprising protecting said current source from voltages above a controllable output voltage of said power converter with a diode in series with said current source.

20. The method as recited in claim 16 further comprising disconnecting said current source from said electronic heater with another disconnect switch in series with said current source.
